(19) United States
(12) Patent Application Publication
(10) Pub. No.: US 2011/0239506 A1
(43) Pub. Date: Oct. 6, 2011

(54) SIGN FRAME

(76) Inventors: Geoffrey M. Glass, JR., Lincolnshire, IL (US); Carol Salas, Gurnee, IL (US)

(21) Appl. No.: 12/755,140

(22) Filed: Apr. 6, 2010

(51) Int. Cl. G09F 15/00; B23P 17/00

(52) U.S. Cl. 40/610; 40/606.01; 29/592

(57) ABSTRACT

A sign frame includes a panel with a first side extension and a second side extension. The first side extension defines an opening for receiving ballast. The first side extension also defines a hollow chamber for storing the ballast. The panel also includes an upper crossbar that extends between distal ends of the first and the second side extensions, and a lower crossbar that extends between proximal ends of the first and the second side extensions. The first and the second side extensions, upper cross bar, and lower crossbar define a front surface and rear surface. The front surface is configured to receive signage.

### BACKGROUND

1. Field

The present invention relates to signage. In particular, the present invention relates to a sign frame assembly for use in displaying signage.

2. Description of Related Art

When advertising a product or service, it is common to post a sign in the region where the product is being sold or the service is being offered. For example, a restaurant may place a sign in front of the restaurant announcing specialties. In some instances, the sign is configured as an A-frame in which two panels are connected via hinges disposed along the top of the respective panels, and the lower portions of the panels are spread apart. The panels may include a large surface for attaching signage. The signage may be attached to the panel with tape, Velcro, and/or nylon straps.

One problem with existing sign frames is that due to the large surface area for placing the signage, the sign frames are prone to tip over in the presence of strong winds. One solution is to place bags of ballast, such as sand, over the sign frame to increase the weight of the sign frame. However, the bags of ballast may obstruct the signage. Some sign frames include openings at the tops of the panels for pouring ballast into a hollow chamber located in a central region of the panel behind the signage. However, to provide for sufficient ballast, the thickness of the panel in the central region needs to be increased, resulting in a thicker and visually less-appealing sign frame.

### SUMMARY

In one aspect, a sign frame includes a panel that includes a first and a second vertical side member. The first vertical side member defines an opening for receiving ballast and also defines at least one hollow chamber for receiving the ballast. An upper crossbar extends between the first and the second vertical side members, and a lower crossbar extends between the first and the second vertical side members. The first and the second vertical side members, upper crossbar, and lower crossbar define a front surface and rear surface. The front surface is configured to receive signage.

### BRIEF DESCRIPTION OF THE DRAWINGS

The accompanying drawings are included to provide a further understanding of the invention and are incorporated in and constitute a part of this specification. The detailed description and illustrated embodiments of the invention serve to explain the principles of the invention.

FIG. 1 is a perspective view of an exemplary sign frame in an open configuration;

FIGS. 2A-2C are front, side, and rear views, respectively, of a panel of the sign frame of FIG. 1;

FIG. 2D is a cross-sectional view of a panel taken along section B-B′ of FIG. 2A

FIGS. 3A and 3B illustrate upper and lower channels of the panel that enable the attachment of signage;

FIGS. 3C and 3D illustrate the attachment of signage to the panel; and

FIGS. 4A and 4B illustrate an exemplary hinge that enables selectively locking the panels in both an open and a closed configuration.

### DETAILED DESCRIPTION

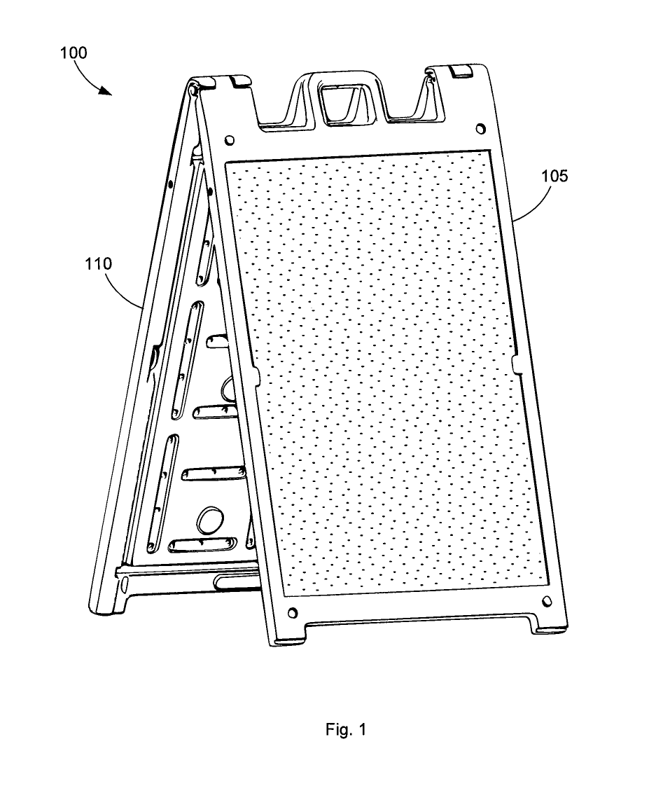

FIG. 1 illustrates a sign frame 100 in an open configuration. The sign frame 100 includes a first panel 105 and a second panel 110. In some implementations, the first panel 105 and the second panel 110 are identical and attach via hinges defined along the top of each panel 105 and 110. In other implementations, the sign frame includes a single panel 105 that is supported differently. For example, a support rod (not shown) may be utilized to prop up the panel 105. The panels 105 and 110 may be made of plastic, metal, or other materials known in the art. The panels 105 and 110 may be formed via a blow-molding process or other molding processes known in the art.

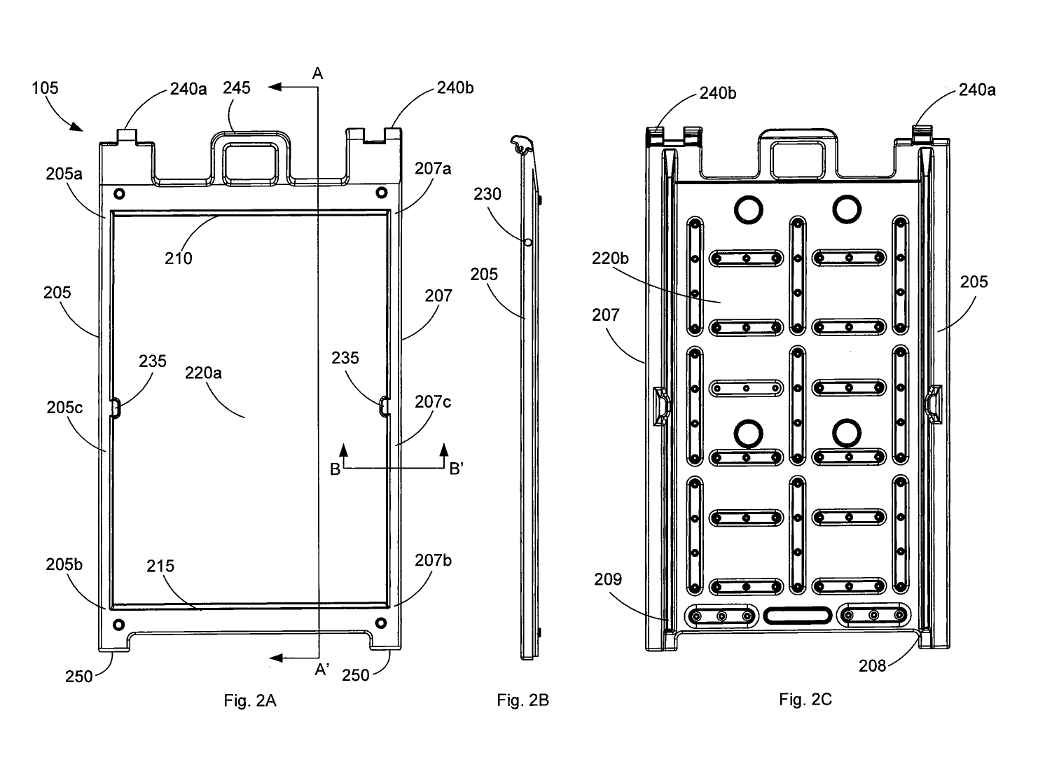

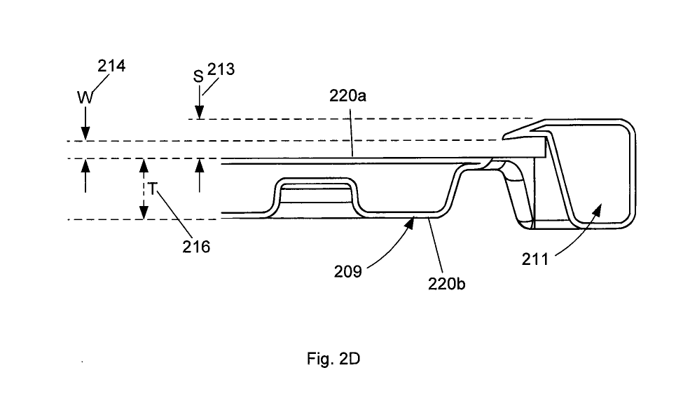

Referring to FIG. 2A, each panel 105 and 110 includes a first side extension 205, a second side extension 207, an upper crossbar 210, and a lower crossbar 215. The upper crossbar 210 extends between the distal end 205a of the first side extension 205 and the distal end 207a of the second side extension 207. The lower crossbar 215 extends between the proximal end 205b of the first side extension 205 and the proximal end 207b of the second side extension 207. The upper crossbar 210, lower crossbar 215, first side extension 205, and second side extension 207 define a front surface 220a and a rear surface 220b.

The front surface 220a of the panel 100 may be generally planar and may be configured to receive signage. For example, signage may be attached to the panel utilizing attachment mechanisms, such as glue, straps, Velcro® or other means known in the art. In other implementations, the upper crossbar 210 and the lower crossbar 215 define channels for receiving the signage

As shown in FIG. 2C, a first groove 208 is positioned between the first side extension 205 and the rear surface 220b, and a second groove 209 is positioned between the second side extension 207 and the rear surface 220b. The first groove 208 and the second groove 209 provide a separation between hollow chambers 211 (FIG. 2D) disposed in the first and the second extensions 205 and 207 and hollow chambers that may be disposed between the front surface 220a and the rear surface 220b.

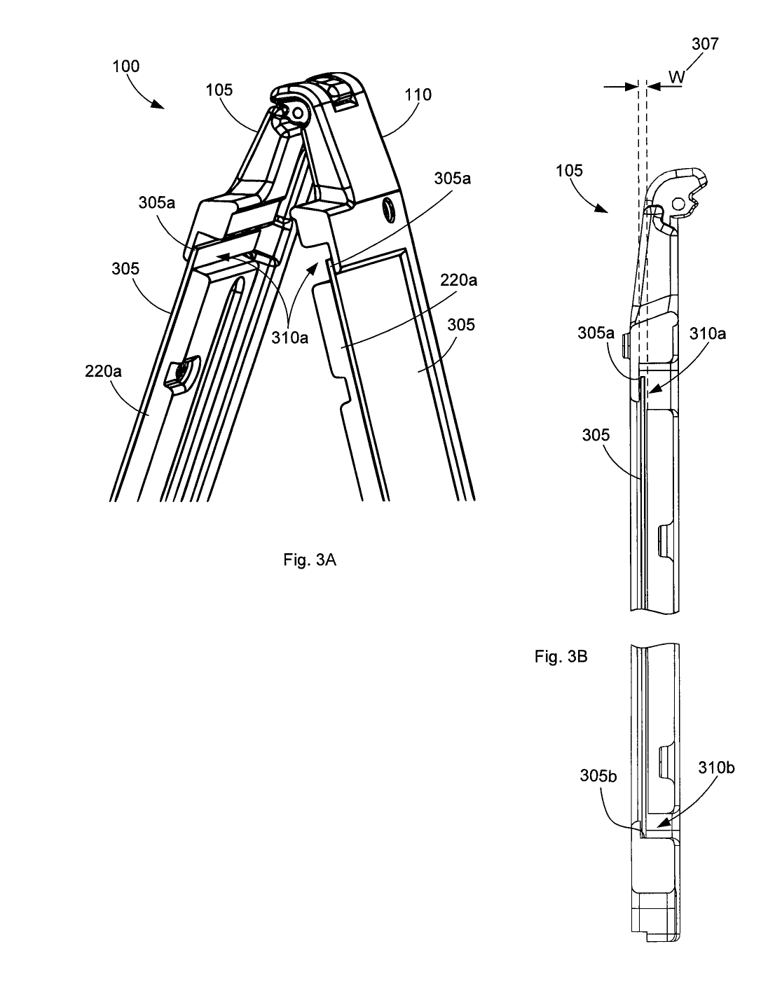

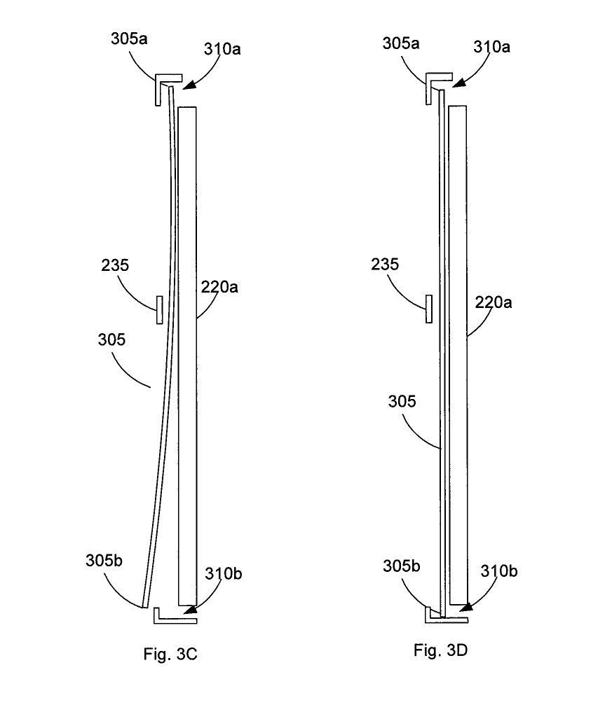

FIGS. 3A and 3B illustrate an exemplary cross-sectional view of the sign frame 100 taken along section A-A′ (FIG. 2A) of the front surface 220a of the panel 105 and illustrate the attachment of signage 305 to the panel 105. Shown in FIGS. 3A and 3B are an upper channel 310a, a lower channel 310b, and exemplary signage 305. The upper channel 310a and lower channel 310b may be define a U-shaped or have an alternative shape. The upper channel 310a may extend between the distal ends 205a and 207a of the first and second side extensions 205 and 207 or may extend in a finite number of regions between the first and second side extensions 205 and 207. The lower channel 310b may extend between the proximal ends 205b and 207b of the first and second the side extensions 205 and 207, or may extend in a finite number of regions between the first and the second side extensions 205 and 207. The width W 307 of the upper channel 310a and the lower channel 310b may be sized to receive the signage. For example, the width W 307 of the respective channels may be generally the same as or larger than the thickness of the signage 305.

Referring to FIGS. 3C and 3B, in operation, the signage 305 is secured to the front surface 220a of the panel 105 by first inserting the lower edge 305abetween the retention tabs 235 and the front surface 220a. Then the upper edge 305a of the signage 305 is inserted into the upper channel 310a, as illustrated in FIG. 3A. This allows the bottom edge 305b of the sign 305 to clear the lower channel 310b and be placed flat against the front surface 220a of the panel 105. Next, the signage 305 is dropped, so that the lower edge 305b of the signage 305 enters into the lower channel 310b, as illustrated in FIG. 3B. The relative depths of the upper channel 305a and the lower channel 305b are configured so that the upper edge 305a of the signage 305 is still disposed within the upper channel 310a when the lower edge 305b is completely disposed within the lower channel 310b.

Referring back to FIG. 2A, one or more retention tabs 235 may extend from the first and the second side extensions 205 and 207 toward the panel surface 220 to further improve retention of the signage to the panel 105 by preventing the signage from bowing in a center region. The retention tabs 235 may be distanced from the panel surface 220a by a value W 214 corresponding to the thickness of the signage, as shown in FIG. 2D. The distance may be increased to enable easier sliding of the signage between the retention tabs 235. Moreover, additional tabs may be placed to further secure the signage to the panel 105.

As shown in FIG. 2B, the first side extension 205 may define an opening 230 for receiving ballast. The first side extension 205 may define a hollow chamber 211 (FIG. 2D) therein for receiving the ballast. The hollow chamber 211 may run the full length of the first side extension 205 to maximize the amount of ballast that may be placed in the first side extension 205. In some implementations, the second side extension 207 also defines an opening for receiving ballast and also defines a hollow chamber 211 therein for storing the ballast. In yet other implementations, the lower crossbar 215 defines a similarly sized hollow chamber in fluid communication with the hollow chambers 211 defined by one or both side extension 205 and 207 and is configured to store additional ballast. At least one advantage to storing the ballast in the first and second side extensions 205 and 207, and/or the lower crossbar 215, is that it enables the thickness T 216 (FIG. 2D) between the front surface 220a and the rear surface 220b of the panel 105 to be decreased. This in turn enables the front surface 220a of the panel 105 to be recessed relative to the front surfaces 205c and 207c of the first and the second side extensions 205 and 207 by an amount S 213 (FIG. 2D), which may correspond to the thickness of the signage or a greater distance. This enables the signage to be flushly mounted to the panel 105 and recessed relative to the first and second side extensions 205 and 207, making it less likely for wind to get behind the signage and potentially pull the signage off the panel 105.

The upper crossbar 210 defines a first hinge 240a and a second hinge 240b. The first hinge 240a and the second hinge 240b are complementary to one another and are configured to engage a first and second hinge 240a and 240b of a second panel. In other words, the first hinge 240a on a first panel is configured to engage the second hinge 240b of a second panel. In some implementations, the first hinge 240a and the second hinge 240b are configured to enable selectively locking a pair of panels 105 in both an open and a closed configuration.

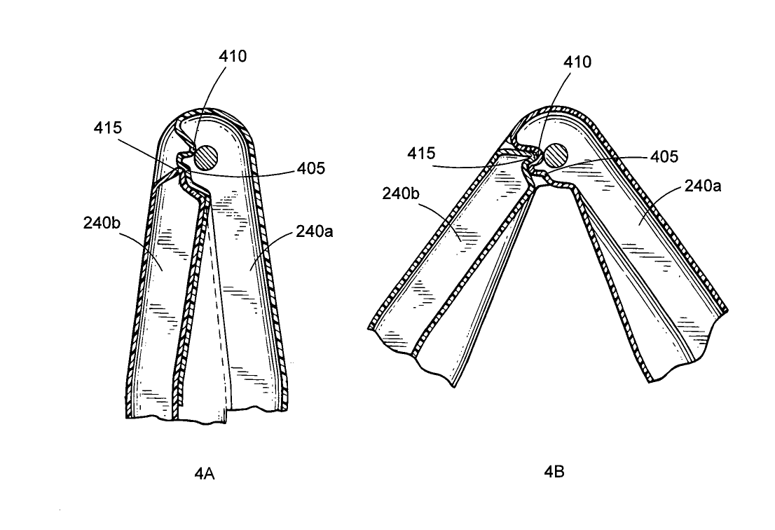

FIGS. 4A and 4B illustrate an exemplary hinge that enables selectively locking the panels in both an open and closed configuration. Shown are a first hinge 240a and a second hinge 240b. The first hinge 240a includes a first recess 405 and a second recess 410. The second hinge 240b includes a finger 415. The finger 415 is configured to releasably snap into the first recess 405 so as to place the panels in a closed configuration, as shown in FIG. 4A. The finger 415 is also configured to releasably snap into the second recess 410 to secure the panels in an open configuration, as shown in FIG. 4B. The tip of the finger 415 may be rounded to enable the finger 415 to more easily slide between the first recess 405 and the second recess 410. In addition, the wall thickness of the finger 415 may be increased or decreased to increase or decrease the stiffness of the finger 415, thus increasing or decreasing the force necessary to move the panels between the open and closed configurations.

Referring back to FIG. 2A, the upper crossbar 210 may also define a handle 245 for carrying the panel 105. The handle 245 may be sized to accommodate an individual's hand. The lower crossbar 215 may define one or more feet 250 for supporting the panel 105 on a surface.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

We claim:

1. A sign frame comprising:
a panel comprising:
a first side extension and a second side extension, wherein said first side extension includes an opening for receiving ballast, and defines a hollow chamber for storing said ballast;
an upper crossbar extending between distal ends of said first and said second side extensions; and
a lower crossbar extending between proximal ends of said first and said second side extensions, wherein said first and said second side extensions, said upper crossbar, and second lower crossbar define a front surface and a rear surface, wherein said front surface is configured to receive signage.

2. The sign frame according to claim 1, wherein said second side extension defines a second hollow chamber for storing ballast, wherein said second side extension includes a second opening for receiving ballast.

3. The sign frame according to claim 2, further comprising a third hollow chamber disposed in said lower crossbar, wherein said third hollow chamber is in fluid communication with at least one of said first hollow chamber and said second hollow chamber.

4. The sign frame according to claim 1, wherein said lower crossbar defines feet for supporting said sign frame.

5. The sign frame according to claim 1, wherein said upper crossbar defines a first hinge member and a second hinge member, said first hinge member being configured to engage a second hinge member of a second panel.

6. The sign frame according to claim 5, wherein said first hinge member and said second hinge member are configured to selectively lock said sign frame in an open position.

7. The sign frame according to claim 5, wherein said first hinge member and said second hinge member are configured to selectively lock said sign frame in a closed position.

8. The sign frame according to claim 1, wherein said upper crossbar defines a handle for carrying said sign frame.

9. The sign frame according to claim 1, further comprising a first tab and a second tab disposed on said first and said second side extensions, respectively, said first and second tabs are configured to enable slidably securing said signage to said front surface.

10. The sign frame according to claim 1, wherein said upper crossbar defines a first channel, and said lower crossbar defines a second channel, and said first and said second channels are configured to secure said signage to said panel.

11. The sign frame according to claim 10, wherein said first and said second channels extend between said first and said second side extensions.

12. A method for manufacturing a sign frame comprising:
forming a first side extension and a second side extension, wherein said first side extension includes an opening for receiving ballast, and defines a hollow chamber for storing said ballast;
forming an upper crossbar between distal ends of said first and said second side extensions; and
forming a lower crossbar between proximal ends of said first and said second side extensions,
wherein said first and said second side extensions, said upper crossbar, and second lower crossbar define a front surface and rear surface, wherein said front surface is configured to receive signage.

13. The method according to claim 12, wherein said hollow chamber is disposed substantially within said first side extension.

14. The method according to claim 12, further comprising forming a second hollow chamber substantially within said second side extension, wherein said second side extension includes a second opening for receiving ballast.

15. The method according to claim 14, further comprising forming a third hollow chamber in said lower crossbar, said third hollow chamber being in fluid communication with said at least one hollow chamber and said second hollow chamber.

16. The method according to claim 12, wherein said upper crossbar defines a first hinge member and a second hinge member and said first hinge member is configured to engage a second hinge member of a second panel.

17. The method according to claim 16, wherein said first hinge member and said second hinge member are configured to selectively lock said sign frame in an open position and a closed position.

18. The method according to claim 12, wherein said upper crossbar defines a first channel, and said lower crossbar defines a second channel, and said first and said second channels are configured to secure signage to said panel.

19. The method according to claim 12, further comprising forming a first tab on said first side extension and a second tab on said second side extension extending towards said front surface for slidably securing said signage to said front surface.

20. The method according to claim 12, wherein said upper crossbar defines a handle for carrying said sign frame.
